(19) United States
(12) Patent Application Publication
(10) Pub. No.: US 2021/0365730 A1
(43) Pub. Date: Nov. 25, 2021

(54) METHOD FOR GENERATING TRAINING DATA AND AN ELECTRONIC DEVICE

(71) Applicant: National Tsing Hua University, Hsinchu City (TW)

(72) Inventors: Min Sun, Hsinchu City (TW); Hung-Kuo Chu, Hsinchu City (TW); Chuan-Wei Wang, Hsinchu City (TW)

(73) Assignee: National Tsing Hua University, Hsinchu City (TW)

(21) Appl. No.: 16/986,280

(22) Filed: Aug. 6, 2020

(30) Foreign Application Priority Data
May 21, 2020 (TW) 109116864

(51) Int. Cl. G06K 9/62; G06K 9/36; G06N 3/08; G06T 3/00

(52) U.S. Cl. CPC G06K 9/6256; G06T 3/0093; G06N 3/08; G06K 9/36

(57) ABSTRACT

The disclosure provides a method for generating training data and an electronic device. The method includes: obtaining an object model of a specific object; obtaining a first image when the object model is positioned at a first angle and a first silhouette corresponding to the first image; retrieving a first object image representing the specific object positioned at the first angle from the first image based on the first silhouette; embedding the first object image into a first background image to generate a first training image; generating a first labeled data of the first object image in the first training image; and defining the first training image and the first labeled data as a first training data of the specific object.

### CROSS-REFERENCE TO RELATED APPLICATION

This application claims the priority benefit of Taiwan application serial no. 109116864, filed on May 21, 2020. The entirety of the above-mentioned patent application is hereby incorporated by reference herein and made a part of this specification.

### BACKGROUND

### Technical Field

This disclosure relates to a deep learning technique and in particular to a method and electronic device for generating training data.

### Description of Related Art

Currently, deep learning requires huge amount of training materials to obtain good results. However, during the process of product development, some training materials are difficult to obtain, making it time-consuming and costly for the manufacturers.

Currently, the generation and collection of training data are usually done through manual labeling, however, due to the difficulties involved in manual labeling of human body postures or object postures, large amount of time is required and high error rate is observed.

In addition, for items unique to certain manufacturers (such as a product), it is not possible to use existing open data sets, therefore requiring the manufacturers to collect data themselves, further incurring extra time and costs.

### SUMMARY

The disclosure provides a method for generating training data and an electronic device.

An embodiment of the disclosure provides a method for generating training data. The method includes: obtaining an object model of a specific object; obtaining a first image when the object model is positioned at a first angle and a first silhouette corresponding to the first image; retrieving a first object image representing the specific object positioned at the first angle from the first image based on the first silhouette; embedding the first object image into a first background image to generate a first training image; generating a first labeled data of the first object image in the first training image; and defining the first training image and the first labeled data as a first training data of the specific object.

An embodiment of the disclosure provides an electronic device, including a storage circuit and a processor. The storage circuit stores multiple modules. The processor is coupled to the storage circuit and accesses the aforementioned modules to perform the following steps: obtaining an object model of a specific object; obtaining a first image when the object model is positioned at a first angle and a first silhouette corresponding to the first image; retrieving a first object image representing the specific object positioned at the first angle from the first image based on the first silhouette; embedding the first object image into a first background image to generate a first training image; generating a first labeled data of the first object image in the first training image; and defining the first training image and the first labeled data as a first training data of the specific object.

Based on the above, the embodiments of the disclosure automatically, quickly and correctly generate training data, therefore reducing the associated time and money costs.

### BRIEF DESCRIPTION OF THE DRAWINGS

FIG. 1 is a schematic diagram of an electronic device according to an embodiment of the disclosure.

FIG. 2 is a flowchart of a method for generating training data according to an embodiment of the disclosure.

FIG. 3 is a schematic diagram of an object model according to an embodiment of the disclosure.

FIG. 4 is a schematic diagram of retrieving the first object image of FIG. 3.

FIG. 5A is a schematic diagram of generating a first training image according to an embodiment of the disclosure.

5B and 5C are schematic diagrams of generating training images according to different embodiments of the disclosure.

FIG. 6 is a schematic diagram of retrieving the second object image of FIG. 3.

### DESCRIPTION OF THE EMBODIMENTS

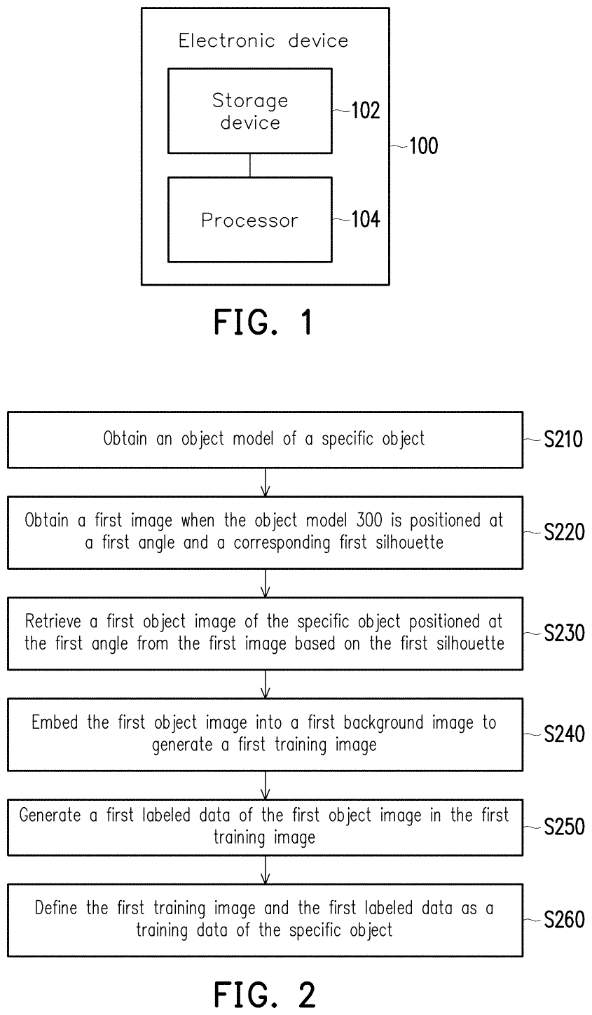

Referring to FIG. 1, FIG. 1 is a schematic diagram of an electronic device according to an embodiment of the disclosure. In different embodiments of the disclosure, an electronic device 100 may be an any type of computer devices, such as personal computers, cloud servers, workstations, notebook computers, etc., or any type of smart devices, such as smartphones and tablets, etc. However, the disclosure is not limited thereto.

As shown in FIG. 1, the electronic device 100 may include a storage circuit 102 and a processor 104. The storage circuit 102 is, for example, any type of fixed or removable random access memory (RAM), read-only memory (ROM), flash memory, hard disk or any other similar devices or a combination of these devices, and is used to record multiple codes or modules.

The processor 104 is coupled to the storage circuit 102, and is a general-purpose processor, a special-purpose processor, a traditional processor, a digital signal processor, multiple microprocessors, a one or more microprocessors that integrates with the core of a digital signal processor, a controller, a microcontroller, an application specific integrated circuit (ASIC), a field programmable gate array (FPGA), any other kind of integrated circuit, a state machine, an Advanced RISC Machine (ARM) processor or any other similar products.

In an embodiment of the disclosure, the processor 104 accesses the modules and program codes recorded in the storage circuit 102 to implement the method for generating training data according to the embodiments, with the details as follows.

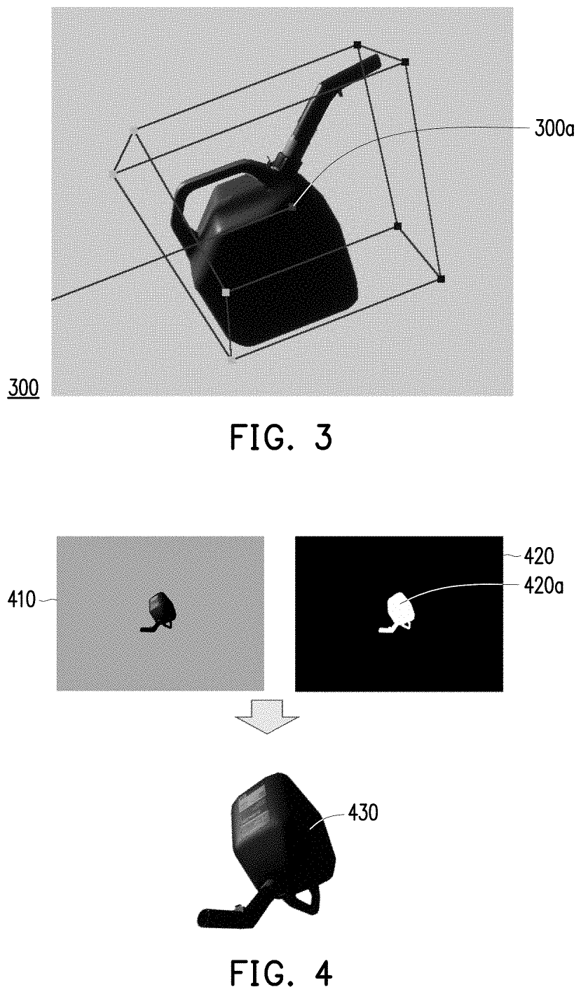

Referring to FIG. 2, which is a flowchart of a method for generating training data according to an embodiment of the disclosure, the method in the embodiment of the disclosure is performed by the electronic device 100 in FIG. 1, and the details of each step in FIG. 2 are described below in accordance with the elements shown in FIG. 1.

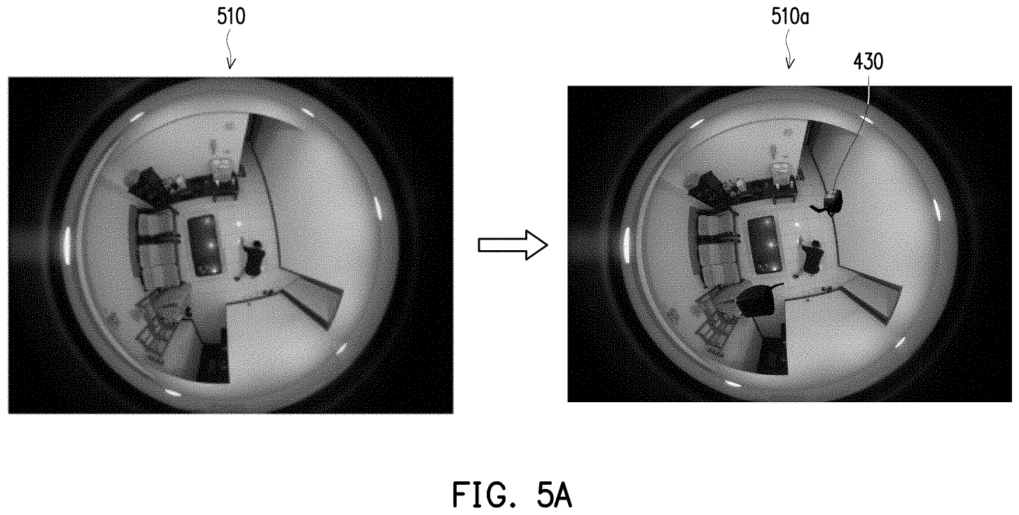

Firstly, in step S210, the processor 104 obtains an object model of a specific object. In some embodiments of the disclosure, the specific object may be a product unique to a manufacturer or various objects, but the disclosure is not limited thereto. In the following, descriptions are made with reference to FIGS. 3, 4, and 5A to 5C. However, such descriptions merely serve as an example and shall not be construed as limitations of the disclosure.

Referring to FIG. 3, which is a schematic diagram of an object model according to an embodiment of the disclosure, in the embodiment of the disclosure, an object model 300 is, for example, a related three-dimensional object model corresponding to a specific object, and its file type may be an .obj file or a .fbx file, but the disclosure is not limited thereto. In FIG. 3, the specific object corresponding to the object model 300 may be, for example, an object with a barrel, a handle, and a spout, but FIG. 3 is merely used for illustrative purposes and shall not be construed as limitations on possible embodiments of the disclosure. In another embodiment of the disclosure, the designer may select any object that is meant for training an artificial intelligence model to identify such object as the specific object, but the disclosure is not limited thereto. In addition, in different embodiments of the disclosure, the object model 300 may have one or more feature points that are labeled by the relevant personnel, and the positions of the feature points are set by the relevant personnel according to the requirements. For example, the object model 300 may have feature points labeled on the spout, handle, bottom of the pot, etc., but the disclosure is not limited thereto.

Subsequently, in step S220, the processor 104 may obtain a first image when the object model 300 is positioned at a first angle and a first silhouette corresponding to the first image, and in step S230, based on the first silhouette, a first object image of the specific object positioned at the first angle is obtained from the first image.

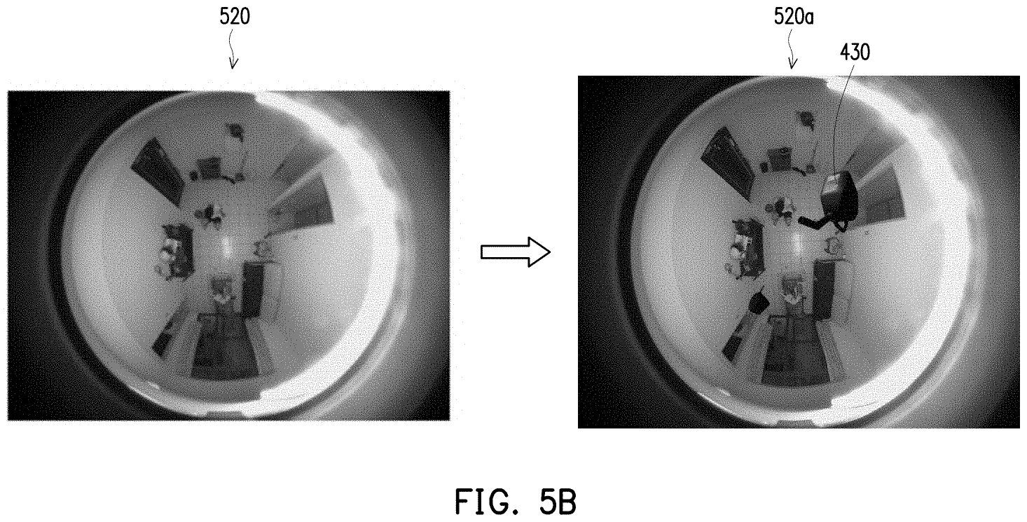

Referring to FIG. 4, which is a schematic diagram of retrieving the first object image of FIG. 3, in the embodiment of the disclosure, it is assumed that the object model 300 is rotated to the first angle as shown in FIG. 4. In this case, the processor 104 may obtain the first image 410 when the object model 300 is positioned at the first angle through taking a screenshot or other similar methods. At the same time, the processor 104 may also obtain the first silhouette 420 that corresponds to the first image 410. In another embodiment of the disclosure, the processor 104 may obtain the first silhouette 420 that corresponds to the first image 410 through a related software function (for example, silhouette function), but the disclosure is not limited thereto.

After obtaining the first image 410 and the first silhouette 420, for example, the processor 104 may retrieve an image area corresponding to a non-shadow portion 420a in the first silhouette 420 from the first image 410 (that is, the specific object at the abovementioned first angle) to serve as a first object image, but the disclosure is not limited to thereto.

Thereafter, in step S240, the processor 104 embeds the first object image 430 into a first background image to generate a first training image.

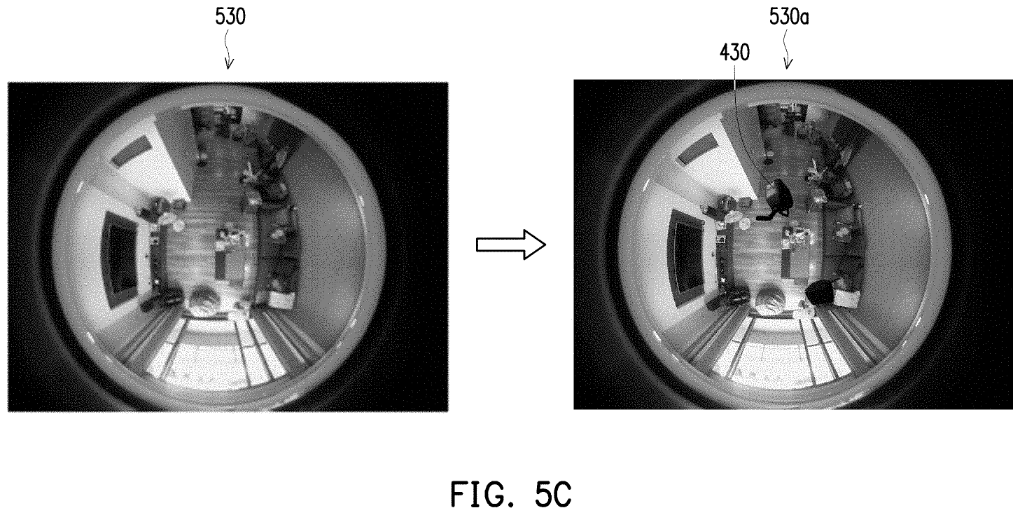

In different embodiments of the disclosure, the first background image may be a pre-stored image of various indoor/outdoor scenes, or a scene image obtained in real time during the shoot, but the disclosure is not limited thereto. Referring to FIG. 5A, FIG. 5A is a schematic diagram of generating a first training image according to an embodiment of the disclosure.

In FIG. 5A, assuming that a first background image 510 acquired by the processor 104 is the fisheye image as shown, the processor 104 may correspondingly embed the first object image 430 into the first background image 510 to generate a first training image 510a. In an embodiment of the disclosure, the processor 104 may embed the first object image 430 into the first background image 510 in any position to generate the first training image 510a, but the disclosure is not limited thereto.

Then, in step S250, the processor 104 may generate a first labeled data of the first object image 430 in the first training image 510a, and define the first training image 510a and the first labeled data as the training data of the specific object in step S260.

In different embodiments of the disclosure, the processor 104 may generate the first labeled data of the first object image 430 in the first training image 510a based on a bounding box annotation technology, a segmentation technology, or any other existing related annotation technology.

For ease of understanding, the following paragraphs assume that the processor 104 uses the bounding box annotation technology, but the disclosure is not limited thereto. Specifically, in FIG. 3, for example, the object model 300 may have a reference point 300a and the reference point 300a exists in both the first image 410 and the first object image 430.

In an embodiment of the disclosure, after the object model 300 is rotated to the first angle in FIG. 4, the processor 104 may automatically generate the corresponding bounding box. In an embodiment of the disclosure, the bounding box is, for example, a rectangular frame that selects the specific object in the first image 410, but the disclosure is not limited thereto. In this case, the processor 104 may record the relative positions of the upper left corner and the lower right corner of the bounding box with respect to the reference point 300a. For example, if the reference point 300a in the first image 410 is regarded as the origin in a coordinate system, then the relative positions of the upper left corner and the lower right corner of the bounding box to the reference point 300a are the coordinates of the corners relative to the origin respectively, but the disclosure is not limited thereto.

Therefore, in the process of embedding the first object image 430 into the first background image 510, the processor 104 may first determine a position that is to be embedded on the first background image 510, then align the reference point 300a in the first object image 430 to the position to be embedded to generate the first training image 510a.

After which, the processor 104 may locate the positions of the upper left corner and the lower right corner of the bounding box in the first training image 510a, based on the embedded position that corresponds to the reference point 300a, and record the information of the positions as the first labeled data. In different embodiments of the disclosure, the first labeled data is, for example, a JSON file, a .txt file, or any other similar description files, but the disclosure is not limited thereto.

Alternatively if the segmentation technology is adopted, after the processor 140 embeds the first object image 430 into the first background image 510 to generate the first training image 510a, the processor 140 also generates an all-black image of the same size as the first background image 510. Next, as the processor 140 knows the embedding position of the first object image 430 in the first background image 510, the processor 140 may then insert a color block that is of the same size and profile as the first object image 430 into the all black image at a position that corresponds to the embedding position to generate the first labeled data that corresponds to the first training image 510a, but the disclosure is not limited thereto.

Further details of the abovementioned bounding box labeled technology and segmentation technology, are found in the relevant technical literature (for example “Russell, BC, Torralba, A., Murphy, K P et al. LabelMe: A Database and Web-Based Tool for Image Labeled. Int J Comput Vis 77, 157-173 (2008). Https://doi.org/10.1007/s11263-007-0090-8”), and will not be repeated here.

In some embodiments of the disclosure, after acquiring the abovementioned first training data, the processor 104 may provide the first training data to the relevant artificial intelligence model to allow the artificial intelligence model to learn to identify the specific object, but the disclosure is not limited thereto.

Therefore, compared to the conventional method for generating training data by manual labeling, an embodiment of the disclosure automatically, accurately and quickly generates the required first training data using the electronic device 100. In addition, since the method according to the embodiments of the disclosure may be implemented in the electronic device 100 as a cloud server, the training data may be generated in the cloud, unlike conventional labeling where the generation of data needs to be completed locally.

In addition, while open data sets related to fisheye images are relatively difficult to obtain, the first training data based on fisheye images is quickly generated by the embodiments of the disclosure. Furthermore, for specific objects unique to certain manufacturers, the embodiments of the disclosure efficiently and correctly generate suitable training data without being limited by existing open data sets.

In some embodiments of the disclosure, the first object image 430 may also be embedded in various background images to generate different sets of training data as learning material for the artificial intelligence model.

Referring to FIG. 5B and FIG. 5C, FIGS. 5B and 5C are schematic diagrams of generating training images according to different embodiments of the disclosure. In FIGS. 5B and 5C, after the processor 104 obtains background images 520 and 530, the first object image 430 is embedded in the background images 520 and 530 to generate training images 520a and 530a respectively, and the relevant labeled data may be obtained according to the above, so the details of which will not be repeated in the following.

After obtaining the training images 520a, 530a and the relevant labeled data, the processor 104 feeds this information into the abovementioned artificial intelligence model to increase the learning ability of the artificial intelligence model in identifying the specific object, but the disclosure is not limited thereto.

In addition to embedding the same object image (such as the first object image 430) into the different background images to produce the different training images, an embodiment of the disclosure may also produce a more diverse range of training images by obtaining a corresponding object image after the object model 300 is rotated to a different angle (hereinafter referred to as a second object image), and embedding the second object image into various background images.

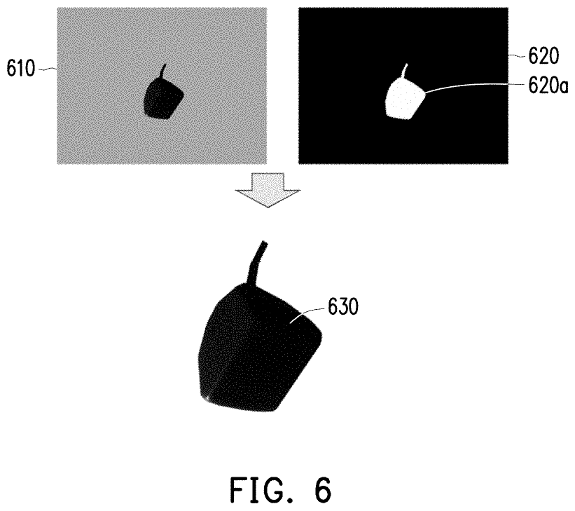

Referring to FIG. 6, which is a schematic diagram of retrieving the second object image of FIG. 3, in an embodiment of the disclosure, it is assumed that the object model 300 is rotated to position at a second angle as shown in FIG. 6. In this case, the processor 104 may obtains a second image 610 when the object model 300 is positioned at the second angle through taking a screenshot or other similar methods. At the same time, the processor 104 may also obtains a second silhouette 620 that corresponds to the second image 610.

After obtaining the second image 610 and the second silhouette 620, for example, the processor 104 may retrieve an image area corresponding to a non-shadow portion 620a in the second silhouette 620 from the second image 610 (that is, the specific object at the second angle) to serve as a second object image 630, but the disclosure is not limited thereto.

After which, the processor 104 may embed the second object image 630 into various background images (such as the first background image 510, background images 520, 530, etc.) to generate a more diverse range of training images, but the disclosure is not limited thereto.

In addition, although the above embodiments of the disclosure are illustrated using a fisheye background image, the embodiments of the disclosure are also applicable to a planar background image and a 360-degree background image.

In some embodiments of the disclosure, the background image may also be an image obtained by pre-processing an original image. In different embodiments of the disclosure, the pre-processing includes at least one of various image warping processes, such as affine warping, perspective-n-point (PnP) warping, image warping, image morphing, parametric warping, 2D image transformation, forward warping, inverse warping, non-parametric image warping and mesh warping, but the disclosure is not limited thereto.

In addition, after obtaining the training image, an embodiment of the disclosure may further update the training image by performing the image warping, but the disclosure is not limited thereto.

In some embodiments of the disclosure, after obtaining the training image, different image amplification methods (for example, providing different light sources/shooting angles) may be used to increase the amount of data, but the disclosure is not limited thereto.

In summary, in the embodiments of the disclosure, the object images corresponding to the positions of the specific object at various angles are embedded into various background images to automatically, quickly and accurately generate the required training data. In addition, according to the embodiments of the disclosure, the generation of the training data may be completed in the cloud, unlike conventional labeling that need to be completed locally. Moreover, according to an embodiment of the disclosure, training data based on fisheye images may be quickly generated. Furthermore, according to the embodiments of the disclosure, for specific objects unique to certain manufacturers, suitable training data may be generated efficiently and correctly without being limited by existing open data sets.

Although the disclosure has been described with reference to the abovementioned embodiments, it is not intended to be exhaustive or to limit the disclosure to the precise form or to exemplary embodiments disclosed. It is apparent to one of ordinary skill in the art that modifications to the described embodiments may be made without departing from the spirit and the scope of the disclosure. Accordingly, the scope of the disclosure is defined by the claims appended hereto and their equivalents in which all terms are meant in their broadest reasonable sense unless otherwise indicated.

What is claimed is:

1. A method for generating training data, comprising:
obtaining an object model of a specific object;
obtaining a first image when the object model is positioned at a first angle and a first silhouette corresponding to the first image;
retrieving a first object image representing the specific object positioned at the first angle from the first image based on the first silhouette;
embedding the first object image into a first background image to generate a first training image;
generating a first labeled data of the first object image in the first training image; and
defining the first training image and the first labeled data as a first training data of the specific object.

2. The method according to claim 1, further comprising:
obtaining a second image when the object model is positioned at a second angle and a second silhouette corresponding to the second image;
retrieving a second object image representing the specific object positioned at the second angle from the second image based on the second silhouette;
embedding the second object image into a second background image to generate a second training image;
generating a second labeled data of the second object image in the second training image; and
defining the second training image and the second labeled data as a second training data of the specific object.

3. The method according to claim 2, further comprising:
feeding the first training data and the second training data into an artificial intelligence model to train the artificial intelligence object model to identify the specific object.

4. The method according to claim 1, further comprising:
obtaining a first original image and pre-processing the first original image to generate the first background image.

5. The method according to claim 4, wherein the pre-processing comprises at least one of affine warping, perspective-n-point (PnP) warping, image warping, image morphing, parametric warping, 2D image transformation, forward warping, inverse warping, non-parametric image warping and mesh warping.

6. The method according to claim 1, further comprising:
performing an image warping process on the first training image to update the first training image.

7. The method according to claim 1, wherein the first background image comprises at least one of a plane image, a fisheye image, and a 360 degree image.

8. The method according to claim 1, wherein generating the first labeled data of the first object image in the first background image comprises:
generating the first labeled data of the first object image in the first training image based on a bounding box annotation technology or a segmentation technology.

9. The method according to claim 1, wherein the first labeled data is associated with a first image area occupied by the first object image in the first background image.

10. The method according to claim 1, further comprising:
obtaining a third image when the object model is positioned at a third angle and a third silhouette corresponding to the third image;
retrieving a third object image representing the specific object positioned at the third angle from the third image based on the third silhouette;
embedding the third object image into the first background image to generate a third training image;
generating a third labeled data of the third object image in the third training image; and
defining the third training image and the third labeled data as a third training data of the specific object.

11. An electronic device, comprising:
a storage circuit storing a plurality of modules; and
a processor coupling to the storage circuit and accessing the modules to perform:
obtaining an object model of a specific object;
obtaining a first image when the object model is positioned at a first angle and a first silhouette corresponding to the first image;
retrieving a first object image representing the specific object positioned at the first angle from the first image based on the first silhouette;
embedding the first object image into a first background image to generate a first training image;
generating a first labeled data of the first object image in the first training image; and
defining the first training image and the first labeled data as a first training data of the specific object.
